(19) United States
(12) Patent Application Publication
(10) Pub. No.: US 2024/0340714 A1
(43) Pub. Date: Oct. 10, 2024

(54) METHOD, APPARATUS, AND COMPUTER PROGRAM FOR ENHANCING DUAL CONNECTIVITY

(71) Applicant: Nokia Technologies Oy, Espoo (FI)

(72) Inventors: Halit Murat GÜRSU, Munich (DE); Philippe GODIN, Massy (FR); Sung Hwan WON, Dallas, TX (US); Ömer BULAKCI, Munich (DE); Muhammad NASEER-UL-ISLAM, Munich (DE); Ahmad AWADA, Munich (DE)

(21) Appl. No.: 18/294,023

(22) PCT Filed: Jul. 5, 2022
(86) PCT No.: PCT/EP2022/068569

§ 371 Date: Jan. 31, 2024

Related U.S. Application Data
(60) Provisional application No. 63/228,721, filed on Aug. 3, 2021.

(51) Int. Cl. H04W 36/00; H04W 48/18; H04W 60/04

(52) U.S. Cl. CPC H04W 36/0069; H04W 48/18; H04W 60/04

(57) ABSTRACT

There is provided an apparatus comprising means for: determine, at a target master node of a master cell group associated with a communications device, one or more of: a target secondary node of a secondary cell group associated with the communications device for providing dual connectivity for the communications device; and one or more secondary cells of the target secondary node, wherein the determining uses information associated with one or more of; one or more allowed and/or configured slices of the communications device; and a registration area of the communications device.

### FIELD

The present application relates to a method, apparatus, and computer program and in particular but not exclusively a method, apparatus, and computer program relating to dual connectivity.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standards are the so-called 5G standards.

Slicing is a concept which has been introduced in 5G. An operator transforms its network into a set of logical networks on top of a shared infrastructure. Each logical network (known as a slice) of the set of logical networks may be designed to serve at least one defined purpose and comprises the required network resources, configured and connected end-to-end. The slices may be assigned to a subscriber for the desired services

### SUMMARY

According to an aspect, there is provided a method comprising: determining, at a target master node of a master cell group associated with a communications device, one or more of: a target secondary node of a secondary cell group associated with the communications device for providing dual connectivity for the communications device; and one or more secondary cells of the target secondary node, wherein the determining uses information associated with one or more of, one or more allowed and/or configured slices of the communications device; and a registration area of the communications device.

The determining may comprise determining the target secondary node from a plurality of candidate secondary nodes.

The determining may comprise comprises determining the one or more secondary cells from a plurality of candidate secondary cells.

The method may comprise receiving said information.

The method may comprise receiving said information from a source master node.

The method may comprise receiving at the target master node a handover request for the target master node to be the master node of the master cell group associated with the communications device.

The method may comprise receiving the information in the handover request.

The information associated with the registration area may comprise the registration area of the communications device.

The information associated with the one or more allowed slices may comprise a list of allowed slices.

The list of allowed slices may be provided by allowed network slice selection assistance information.

The method may comprise causing a request to be sent to the target secondary node.

The request to be sent to the target secondary node may comprise a secondary node addition request.

The request to be sent to the target secondary node may comprise a secondary node modification request.

The request to be sent to the target secondary node may comprise information associated with one or more of: one or more allowed slices of the communications device; and the registration area of the communications device

The information about the registration area in the request may comprise the registration area.

The information about the one or more allowed slices in the request may comprise allowed network slice selection assistance information The request to be sent to the target secondary node may comprise information about one or more candidate secondary node cells.

The one or more candidate secondary node cells may belong to one or more tracking areas associated with the registration area of the communications device.

The request to be sent to the target secondary node may comprise information about one or more candidate secondary node cells supporting one or more slices of the one or more allowed slices of the communications device.

The method may comprise determining the target secondary node based on a tracking area of the target secondary node being associated with the registration area.

The method may comprise determining the target secondary node based on one or more matches between one or more allowed slices of the communications device and one or more slices supported by one or more secondary cells of one or more candidate target secondary nodes

The request to be sent to the target secondary node may comprise one or more candidate secondary node cells based on one or more matches between one or more allowed slices of the communications device and one or more slices supported by the respective one or more candidate secondary cells of the target secondary node.

The one or more candidate target secondary nodes may support one or more of the slices in an ongoing packet data unit session.

The one or more matches may be such as to maximize a number of slices for which there is no ongoing associated packet data unit session

The method may comprise identifying in the one or more matches a slice of highest priority for which there is no ongoing associated packet data unit session.

The method may comprise causing a message to be sent from the target master node to a mobility management function, said message comprising information indicating a tracking area of a secondary cell of the target secondary node which has been added to the secondary cell group associated with the communications device.

The method may be performed by an apparatus. The apparatus may be provided in a radio access node or may be a radio access node. The radio access node may be a target radio access node.

According to another aspect, there is provided an apparatus comprising means configured to: determine, at a target master node of a master cell group associated with a communications device, one or more of: a target secondary node of a secondary cell group associated with the communications device for providing dual connectivity for the communications device; and one or more secondary cells of the target secondary node, wherein the determining uses information associated with one or more of; one or more allowed slices of the communications device; and a registration area of the communications device.

The means may be configured to determine the target secondary node from a plurality of candidate secondary nodes.

The means may be configured to determine the one or more secondary cells from a plurality of candidate secondary cells.

The means may be configured to receive said information.

The means may be configured to receive said information from a source master node.

The means may be configured to receive at the target master node a handover request for the target master node to be the master node of the master cell group associated with the communications device.

The means may be configured to receive the information in the handover request.

The information associated with the registration area may comprise the registration area of the communications device.

The information associated with the one or more allowed slices may comprise a list of allowed slices.

The list of allowed slices may be provided by allowed network slice selection assistance information.

The means may be configured to cause a request to be sent to the target secondary node.

The request to be sent to the target secondary node may comprise a secondary node addition request.

The request to be sent to the target secondary node may comprise a secondary node modification request.

The request to be sent to the target secondary node may comprise information associated with one or more of: one or more allowed slices of the communications device; and the registration area of the communications device The information about the registration area in the request may comprise the registration area.

The information about the one or more allowed slices in the request may comprise allowed network slice selection assistance information The request to be sent to the target secondary node may comprise information about one or more candidate secondary node cells.

The one or more candidate secondary node cells may belong to one or more tracking areas associated with the registration area of the communications device.

The request to be sent to the target secondary node may comprise information about one or more candidate secondary node cells supporting one or more slices of the one or more allowed slices of the communications device.

The means may be configured to determine the target secondary node based on a tracking area of the target secondary node being associated with the registration area.

The means may be configured to determine the target secondary node based on one or more matches between one or more allowed slices of the communications device and one or more slices supported by one or more secondary cells of one or more candidate target secondary nodes The request to be sent to the target secondary node may comprise one or more candidate secondary node cells based on one or more matches between one or more allowed slices of the communications device and one or more slices supported by the respective one or more candidate secondary cells of the target secondary node.

The one or more candidate target secondary nodes may support one or more of the slices in an ongoing packet data unit session.

The one or more matches may be such as to maximize a number of slices for which there is no ongoing associated packet data unit session The means may be configured to identify in the one or more matches a slice of highest priority for which there is no ongoing associated packet data unit session.

The means may be configured to cause a message to be sent from the target master node to a mobility management function, said message comprising information indicating a tracking area of a secondary cell of the target secondary node which has been added to the secondary cell group associated with the communications device.

The apparatus may be provided in a radio access node or may be a radio access node. The radio access node may be a target radio access node.

According to another aspect, there is provided an apparatus, the apparatus comprising at least one processor and at least one memory including a computer program code, the at least one memory and computer program code configured to, with the at least one processor, cause the apparatus at least to: determine, at a target master node of a master cell group associated with a communications device, one or more of: a target secondary node of a secondary cell group associated with the communications device for providing dual connectivity for the communications device; and one or more secondary cells of the target secondary node, wherein the determining uses information associated with one or more of, one or more allowed slices of the communications device; and a registration area of the communications device.

The at least one memory and at least one processor may be configured to cause the apparatus to determine the target secondary node from a plurality of candidate secondary nodes.

The at least one memory and at least one processor may be configured to cause the apparatus to determine the one or more secondary cells from a plurality of candidate secondary cells.

The at least one memory and at least one processor may be configured to cause the apparatus to receive said information.

The at least one memory and at least one processor may be configured to cause the apparatus to receive said information from a source master node.

The at least one memory and at least one processor may be configured to cause the apparatus to receive at the target master node a handover request for the target master node to be the master node of the master cell group associated with the communications device.

The at least one memory and at least one processor may be configured to cause the apparatus to receive the information in the handover request.

The information associated with the registration area may comprise the registration area of the communications device.

The information associated with the one or more allowed slices may comprise a list of allowed slices.

The list of allowed slices may be provided by allowed network slice selection assistance information.

The at least one memory and at least one processor may be configured to cause the apparatus to cause a request to be sent to the target secondary node.

The request to be sent to the target secondary node may comprise a secondary node addition request.

The request to be sent to the target secondary node may comprise a secondary node modification request.

The request to be sent to the target secondary node may comprise information associated with one or more of: one or more allowed slices of the communications device; and the registration area of the communications device The information about the registration area in the request may comprise the registration area.

The information about the one or more allowed slices in the request may comprise allowed network slice selection assistance information

The request to be sent to the target secondary node may comprise information about one or more candidate secondary node cells.

The one or more candidate secondary node cells may belong to one or more tracking areas associated with the registration area of the communications device.

The request to be sent to the target secondary node may comprise information about one or more candidate secondary node cells supporting one or more slices of the one or more allowed slices of the communications device.

The at least one memory and at least one processor may be configured to cause the apparatus to determine the target secondary node based on a tracking area of the target secondary node being associated with the registration area.

The at least one memory and at least one processor may be configured to cause the apparatus to determine the target secondary node based on one or more matches between one or more allowed slices of the communications device and one or more slices supported by one or more secondary cells of one or more candidate target secondary nodes

The request to be sent to the target secondary node may comprise one or more candidate secondary node cells based on one or more matches between one or more allowed slices of the communications device and one or more slices supported by the respective one or more candidate secondary cells of the target secondary node.

The one or more candidate target secondary nodes may support one or more of the slices in an ongoing packet data unit session.

The one or more matches may be such as to maximize a number of slices for which there is no ongoing associated packet data unit session The at least one memory and at least one processor may be configured to cause the apparatus to identify in the one or more matches a slice of highest priority for which there is no ongoing associated packet data unit session.

The at least one memory and at least one processor may be configured to cause a message to be sent from the target master node to a mobility management function, said message comprising information indicating a tracking area of a secondary cell of the target secondary node which has been added to the secondary cell group associated with the communications device.

The apparatus may be provided in a radio access node or may be a radio access node. The radio access node may be a target radio access node.

According to another aspect, there is provided a method comprising: receiving, at a target secondary node of a secondary cell group associated with a communications device, a request from a target master node of a master cell group associated with the communications device, the request comprising one or more of: information associated with one or more allowed slices of the communications device; information associated with a registration area of the communications device; and information about one or more candidate secondary cells of the target secondary node.

The method may comprise determining one or more target secondary node cells of the target secondary node based on a tracking area of the target secondary node which is associated with the registration area.

The method may comprise selecting one or more secondary node cells of the target secondary node based on a match between the information associated with one or more allowed slices of the communications device and one or more slices supported by the respective secondary node cells.

The information associated with the one or more allowed slices may comprise a list of allowed slices.

The list of allowed slices may be provided by allowed network slice selection assistance information.

The information associated with the registration area may comprise the registration area of the communications device.

The request may comprise one of a secondary node addition request and a secondary node modification request.

The method may be performed by an apparatus. The apparatus may be provided in a radio access node or may be a radio access node. The radio access node may be a target secondary node.

According to another aspect, there is provided an apparatus comprising means configured to: receive, at a target secondary node of a secondary cell group associated with a communications device, a request from a target master node of a master cell group associated with the communications device, the request comprising one or more of: information associated with one or more allowed slices of the communications device; information associated with a registration area of the communications device; and information about one or more candidate secondary cells of the target secondary node.

The means may be configured to determine one or more target secondary node cells of the target secondary node based on a tracking area of the target secondary node which is associated with the registration area.

The means may be configured to select one or more secondary node cells of the target secondary node based on a match between the information associated with one or more allowed slices of the communications device and one or more slices supported by the respective secondary node cells.

The information associated with the one or more allowed slices may comprise a list of allowed slices.

The list of allowed slices may be provided by allowed network slice selection assistance information.

The information associated with the registration area may comprise the registration area of the communications device.

The request may comprise one of a secondary node addition request and a secondary node modification request.

The apparatus may be provided in a radio access node or may be a radio access node. The radio access node may be a target secondary node.

According to another aspect, there is provided an apparatus, the apparatus comprising at least one processor and at least one memory including a computer program code, the at least one memory and computer program code configured to, with the at least one processor, cause the apparatus at least to: receive, at a target secondary node of a secondary cell group associated with a communications device, a request from a target master node of a master cell group associated with the communications device, the request comprising one or more of: information associated with one or more allowed slices of the communications device; information associated with a registration area of the communications device; and information about one or more candidate secondary cells of the target secondary node.

The at least one memory and at least one processor may be configured to cause the apparatus to determine one or more target secondary node cells of the target secondary node based on a tracking area of the target secondary node which is associated with the registration area.

The at least one memory and at least one processor may be configured to cause the apparatus to select one or more secondary node cells of the target secondary node based on a match between the information associated with one or more allowed slices of the communications device and one or more slices supported by the respective secondary node cells.

The information associated with the one or more allowed slices may comprise a list of allowed slices.

The list of allowed slices may be provided by allowed network slice selection assistance information.

The information associated with the registration area may comprise the registration area of the communications device.

The request may comprise one of a secondary node addition request and a secondary node modification request.

The apparatus may be provided in a radio access node or may be a radio access node. The radio access node may be a target secondary node.

According to another aspect, there is provided a method comprising: causing, by a source master node of a master cell group associated with a communications device, information to be provided to a target master node, the information associated with one or more of: one or more allowed slices of the communications device; and a registration area of the communications device.

The method may comprise receiving at the source master node information associated with the registration area of the communications device from an access management function.

The information may be received by the source master node in an initial context setup message for the communications device.

The information may be received by the source master node in a handover request message.

The information may be provided by the source master node to the target master node in a handover request for handing over from the source master node to the target master node.

The information may be used by the target master node when determining if there is one or more of: a target secondary node of a secondary cell group associated with the communications device for providing dual connectivity for the communications device; and one or more secondary cells of the target secondary node,

The information associated with the registration area may comprise the registration area of the communications device.

The information associated with the one or more allowed slices comprises a list of allowed slices.

The list of allowed slices may be provided by allowed network slice selection assistance information.

The method may be performed by an apparatus. The apparatus may be provided in a radio access node or may be a radio access node. The radio access node may be a source radio access node.

According to another aspect, there is provided an apparatus comprising means configured to: cause, by a source master node of a master cell group associated with a communications device, information to be provided to a target master node, the information associated with one or more of: one or more allowed slices of the communications device; and a registration area of the communications device.

The means may be configured to receive at the source master node information associated with the registration area of the communications device from an access management function.

The information may be received by the source master node in an initial context setup message for the communications device.

The information may be received by the source master node in a handover request message.

The information may be provided by the source master node to the target master node in a handover request for handing over from the source master node to the target master node.

The information may be used by the target master node when determining if there is one or more of: a target secondary node of a secondary cell group associated with the communications device for providing dual connectivity for the communications device; and one or more secondary cells of the target secondary node,

The information associated with the registration area may comprise the registration area of the communications device.

The information associated with the one or more allowed slices comprises a list of allowed slices.

The list of allowed slices may be provided by allowed network slice selection assistance information.

The apparatus may be provided in a radio access node or may be a radio access node. The radio access node may be a source radio access node.

According to another aspect, there is provided an apparatus, the apparatus comprising at least one processor and at least one memory including a computer program code, the at least one memory and computer program code configured to, with the at least one processor, cause the apparatus at least to: cause, by a source master node of a master cell group associated with a communications device, information to be provided to a target master node, the information associated with one or more of: one or more allowed slices of the communications device; and a registration area of the communications device.

The at least one memory and at least one processor may be configured to cause the apparatus to receive at the source master node information associated with the registration area of the communications device from an access management function.

The information may be received by the source master node in an initial context setup message for the communications device.

The information may be received by the source master node in a handover request message.

The information may be provided by the source master node to the target master node in a handover request for handing over from the source master node to the target master node.

The information may be used by the target master node when determining if there is one or more of: a target secondary node of a secondary cell group associated with the communications device for providing dual connectivity for the communications device; and one or more secondary cells of the target secondary node,

The information associated with the registration area may comprise the registration area of the communications device.

The information associated with the one or more allowed slices comprises a list of allowed slices.

The list of allowed slices may be provided by allowed network slice selection assistance information.

The apparatus may be provided in a radio access node or may be a radio access node. The radio access node may be a source radio access node.

According to another aspect, there is provided a method comprising: determining, at a target master node of a master cell group associated with a communications device, if there is one or more of: a target secondary node of a secondary cell group associated with the communications device for providing dual connectivity for the communications device; and one or more secondary cells of the target secondary node, wherein the determining uses information associated with one or more of: one or more allowed slices of the communications device; and a registration area of the communications device.

The method may comprise, when it is determined there is no target secondary node which can be added to the secondary cell group, causing a message to be sent from the target master node to a mobility management function, said message comprising information that there is no secondary node which can be added to the secondary cell group.

The method may comprise determining there is no target secondary node which can be added to the secondary cell group based on there being no target secondary nodes associated with the registration area of the communications device.

The information in the message comprises information indicating that dual connectivity cannot be started for the communications device in dependence on the registration area of the communications device.

The method may be performed by an apparatus. The apparatus may be provided in a radio access node or may be a radio access node. The radio access node may be target radio access node.

According to another aspect, there is provided an apparatus comprising means configured to: determine, at a target master node of a master cell group associated with a communications device, if there is one or more of: a target secondary node of a secondary cell group associated with the communications device for providing dual connectivity for the communications device; and one or more secondary cells of the target secondary node, wherein the determining uses information associated with one or more of: one or more allowed slices of the communications device; and a registration area of the communications device.

The means may be configured to, when it is determined there is no target secondary node which can be added to the secondary cell group, cause a message to be sent from the target master node to a mobility management function, said message comprising information that there is no secondary node which can be added to the secondary cell group.

The means may be configured to determine there is no target secondary node which can be added to the secondary cell group based on there being no target secondary nodes associated with the registration area of the communications device.

The information in the message comprises information indicating that dual connectivity cannot be started for the communications device in dependence on the registration area of the communications device.

The apparatus may be provided in a radio access node or may be a radio access node. The radio access node may be target radio access node.

According to another aspect, there is provided an apparatus, the apparatus comprising at least one processor and at least one memory including a computer program code, the at least one memory and computer program code configured to, with the at least one processor, cause the apparatus at least to: determine, at a target master node of a master cell group associated with a communications device, if there is one or more of: a target secondary node of a secondary cell group associated with the communications device for providing dual connectivity for the communications device; and one or more secondary cells of the target secondary node, wherein the determining uses information associated with one or more of: one or more allowed slices of the communications device; and a registration area of the communications device.

The at least one memory and at least one processor may be configured to cause the apparatus to, when it is determined there is no target secondary node which can be added to the secondary cell group, cause a message to be sent from the target master node to a mobility management function, said message comprising information that there is no secondary node which can be added to the secondary cell group.

The at least one memory and at least one processor may be configured to cause the apparatus to determine there is no target secondary node which can be added to the secondary cell group based on there being no target secondary nodes associated with the registration area of the communications device.

The information in the message comprises information indicating that dual connectivity cannot be started for the communications device in dependence on the registration area of the communications device.

The apparatus may be provided in a radio access node or may be a radio access node. The radio access node may be target radio access node.

According to another aspect, there is provided a method comprising determining that a communications device context is to be setup for communications device with a radio access node or a communications device is to be handed over to a radio access node; and causing a message to be transmitted to the radio access node, said message being to setup or handover the communications device context and including information associated with a registration area of the communications device.

The information associated with the registration area may be the registration area of the communications device.

The radio access node may serve as master node of a master cell group associated with the communications device, in a dual connectivity relationship with the communications device.

The message may comprise one or more of a one of an initial context setup message and an application protocol handover request message.

The message may comprise one or more of a one of a next generation application protocol initial context setup message and a next generation application protocol handover request message.

The method may be performed by an apparatus. The apparatus may be provided in a mobile mobility management function or may be a mobile mobility management function.

According to another aspect, there is provided an apparatus comprising means configured to: determine that a communications device context is to be setup for communications device with a radio access node or a communications device is to be handed over to a radio access node; and cause a message to be transmitted to the radio access node, said message being to setup or handover the communications device context and including information associated with a registration area of the communications device.

The information associated with the registration area may be the registration area of the communications device.

The radio access node may serve as master node of a master cell group associated with the communications device, in a dual connectivity relationship with the communications device.

The message may comprise one or more of a one of an initial context setup message and an application protocol handover request message.

The message may comprise one or more of a one of a next generation application protocol initial context setup message and a next generation application protocol handover request message.

The apparatus may be provided in a mobile mobility management function or may be a mobile mobility management function.

According to another aspect, there is provided an apparatus, the apparatus comprising at least one processor and at least one memory including a computer program code, the at least one memory and computer program code configured to, with the at least one processor, cause the apparatus at least to: determine that a communications device context is to be setup for communications device with a radio access node or a communications device is to be handed over to a radio access node; and cause a message to be transmitted to the radio access node, said message being to setup or handover the communications device context and including information associated with a registration area of the communications device.

The information associated with the registration area may be the registration area of the communications device.

The radio access node may serve as master node of a master cell group associated with the communications device, in a dual connectivity relationship with the communications device.

The message may comprise one or more of a one of an initial context setup message and an application protocol handover request message.

The message may comprise one or more of a one of a next generation application protocol initial context setup message and a next generation application protocol handover request message.

The apparatus may be provided in a mobile mobility management function or may be a mobile mobility management function.

According to another aspect, there is provided a method comprising: causing a message to be sent from a master node of a master cell group associated with a communications device to a mobility management function, said message comprising information indicating a tracking area of a secondary cell of a secondary node which has been added to a secondary cell group associated with the communications device.

The method may be performed by an apparatus. The apparatus may be provided in a radio access node or may be a radio access node.

According to another aspect, there is provided an apparatus comprising means configured to: cause a message to be sent from a master node of a master cell group associated with a communications device to a mobility management function, said message comprising information indicating a tracking area of a secondary cell of a secondary node which has been added to a secondary cell group associated with the communications device.

The apparatus may be provided in a radio access node or may be a radio access node.

According to another aspect, there is provided an apparatus, the apparatus comprising at least one processor and at least one memory including a computer program code, the at least one memory and computer program code configured to, with the at least one processor, cause the apparatus at least to: cause a message to be sent from a master node of a master cell group associated with a communications device to a mobility management function, said message comprising information indicating a tracking area of a secondary cell of a secondary node which has been added to a secondary cell group associated with the communications device.

The apparatus may be provided in a radio access node or may be a radio access node.

According to another aspect, there is provided a method comprising: receiving a message at a mobility management function from a master node of a master cell group associated with a communications device to a mobility management function, said message comprising information indicating a tracking area of a cell of a secondary node of a secondary cell group associated with the communications device; and determining if the tracking area of the cell of the secondary node is associated with a registration area associated with the communications device.

The method may comprise updating the registration area of the communications device based on the received information.

The method may be performed by an apparatus. The apparatus may be provided in a mobile mobility management function or may be a mobile mobility management function.

According to another aspect, there is provided an apparatus comprising means configured to: receive a message at a mobility management function from a master node of a master cell group associated with a communications device to a mobility management function, said message comprising information indicating a tracking area of a cell of a secondary node of a secondary cell group associated with the communications device; and determine if the tracking area of the cell of the secondary node is associated with a registration area associated with the communications device.

The means may be configured to update the registration area of the communications device based on the received information.

The apparatus may be provided in a mobile mobility management function or may be a mobile mobility management function.

According to another aspect, there is provided apparatus, the apparatus comprising at least one processor and at least one memory including a computer program code, the at least one memory and computer program code configured to, with the at least one processor, cause the apparatus at least to: receive a message at a mobility management function from a master node of a master cell group associated with a communications device to a mobility management function, said message comprising information indicating a tracking area of a cell of a secondary node of a secondary cell group associated with the communications device; and determine if the tracking area of the cell of the secondary node is associated with a registration area associated with the communications device.

The at least one memory and at least one processor may be configured to cause the apparatus to update the registration area of the communications device based on the received information.

The apparatus may be provided in a mobile mobility management function or may be a mobile mobility management function.

According to another aspect, there is provided a method comprising: determining, at a target master node of a master cell group associated with a communications device, that that there is no candidate target secondary node of a secondary cell group associated with the communications device to provide dual connectivity for the communications device, wherein the determining uses information associated with one or more of: one or more allowed slices of the communications device; and a registration area of the communications device; and in response to determining that there is no candidate target secondary node, identifying one or more candidate tracking areas not included in the registration area and which if included in the registration area would enable a candidate target secondary node to be selected to provide dual connectivity for the communications device.

The method may comprise causing a message to be sent to a mobility management function including one or more of the identified candidate tracking areas.

The information associated with the registration area may comprise the registration area of the communications device.

The information associated with the one or more allowed slices may comprise a list of allowed slices.

The list of allowed slices may be provided by allowed network slice selection assistance information.

The method may comprise determining that there is no candidate target secondary node when there is no target secondary node associated with the registration area of the communications device.

The information associated with a tracking area may comprise a list of S-NSSAIs supported by the tracking area.

The method may be performed by an apparatus. The apparatus may be provided in a radio access node or may be a radio access node.

According to another aspect, there is provided an apparatus comprising means configured to: determine, at a target master node of a master cell group associated with a communications device, that that there is no candidate target secondary node of a secondary cell group associated with the communications device to provide dual connectivity for the communications device, wherein the determining uses information associated with one or more of: one or more allowed slices of the communications device; and a registration area of the communications device; and in response to determining that there is no candidate target secondary node, identify one or more candidate tracking areas not included in the registration area and which if included in the registration area would enable a candidate target secondary node to be selected to provide dual connectivity for the communications device.

The means may be configured to cause a message to be sent to a mobility management function including one or more of the identified candidate tracking areas.

The information associated with the registration area may comprise the registration area of the communications device.

The information associated with the one or more allowed slices may comprise a list of allowed slices.

The list of allowed slices may be provided by allowed network slice selection assistance information.

The means may be configured to determine that there is no candidate target secondary node when there is no target secondary node associated with the registration area of the communications device.

The information associated with a tracking area may comprise a list of S-NSSAIs supported by the tracking area.

The apparatus may be provided in a radio access node or may be a radio access node.

According to another aspect, there is provided am apparatus, the apparatus comprising at least one processor and at least one memory including a computer program code, the at least one memory and computer program code configured to, with the at least one processor, cause the apparatus at least to: determine, at a target master node of a master cell group associated with a communications device, that that there is no candidate target secondary node of a secondary cell group associated with the communications device to provide dual connectivity for the communications device, wherein the determining uses information associated with one or more of: one or more allowed slices of the communications device; and a registration area of the communications device; and in response to determining that there is no candidate target secondary node, identify one or more candidate tracking areas not included in the registration area and which if included in the registration area would enable a candidate target secondary node to be selected to provide dual connectivity for the communications device.

The at least one memory and at least one processor may be configured to cause the apparatus to cause a message to be sent to a mobility management function including one or more of the identified candidate tracking areas.

The information associated with the registration area may comprise the registration area of the communications device.

The information associated with the one or more allowed slices may comprise a list of allowed slices.

The list of allowed slices may be provided by allowed network slice selection assistance information.

The at least one memory and at least one processor may be configured to cause the apparatus to determine that there is no candidate target secondary node when there is no target secondary node associated with the registration area of the communications device.

The information associated with a tracking area may comprise a list of S-NSSAIs supported by the tracking area.

The apparatus may be provided in a radio access node or may be a radio access node.

According to another aspect, there is provided a method comprising: receiving at an access management function serving a communications device a message from a radio access node serving the communications device including a list of one or more candidate tracking areas to be added to a registration area of the communications device: determining if one or more of the candidate tracking areas is to be added to the registration area of the communications device to provide an updated registration area; and if one or more tracking areas is added to the registration area of the communications device, triggering a configuration update of the communications device for the updated registration area.

The determining if one or more of the candidate tracking areas is to be added to the registration area of the communications device may comprise determining, for each candidate tracking area, if one or more slices associated with the communications device comprised in a list of slices for the candidate tracking area.

The method may be performed by an apparatus. The apparatus may be provided in a mobile mobility management function or may be a mobile mobility management function.

According to another aspect, there is provided an apparatus comprising means configured to: receive at an access management function serving a communications device a message from a radio access node serving the communications device including a list of one or more candidate tracking areas to be added to a registration area of the communications device: determine if one or more of the candidate tracking areas is to be added to the registration area of the communications device to provide an updated registration area; and if one or more tracking areas is added to the registration area of the communications device, trigger a configuration update of the communications device for the updated registration area.

The means may be configured to determine, for each candidate tracking area, if one or more slices associated with the communications device comprised in a list of slices for the candidate tracking area.

The apparatus may be provided in a mobile mobility management function or may be a mobile mobility management function.

According to another aspect, there is provided an apparatus, the apparatus comprising at least one processor and at least one memory including a computer program code, the at least one memory and computer program code configured to, with the at least one processor, cause the apparatus at least to: receive at an access management function serving a communications device a message from a radio access node serving the communications device including a list of one or more candidate tracking areas to be added to a registration area of the communications device: determine if one or more of the candidate tracking areas is to be added to the registration area of the communications device to provide an updated registration area; and if one or more tracking areas is added to the registration area of the communications device, trigger a configuration update of the communications device for the updated registration area.

The at least one memory and at least one processor may be configured to cause the apparatus to determine, for each candidate tracking area, if one or more slices associated with the communications device comprised in a list of slices for the candidate tracking area.

The apparatus may be provided in a mobile mobility management function or may be a mobile mobility management function.

According to another aspect, there is provided a computer readable medium comprising program instructions for causing an apparatus to perform at least the method according to any of the preceding aspects.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows an example system architecture;

FIG. 2 shows a schematic diagram of an example 5G system;

FIG. 3 shows a schematic diagram of an example communication device;

FIG. 4 shows a schematic diagram of an example apparatus;

FIG. 5 shows the format of S-NSSAI (Single-Network Slice Selection Assistance Information);

FIG. 6 shows message signalling for inter master node handover during dual connectivity operation;

FIG. 7 shows message signalling for inter master node handover during dual connectivity operation of some embodiments;

FIG. 8 shows message signalling for inter master node handover during dual connectivity operation of some embodiments;

FIG. 9 to 17 show flowcharts of method performed by apparatus according to various example embodiments.

### DETAILED DESCRIPTION

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

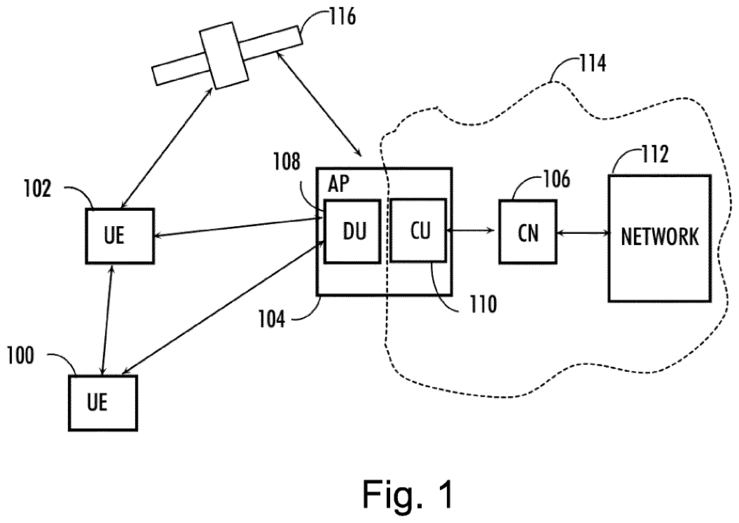

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as (e/g)NodeB serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server, or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the deployed technology, the (e/g)NodeB is connected to a serving and packet data network gateway (S-GW and P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Exemplary embodiments of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, a wireless interface card or other wireless interface facility (e.g., USB dongle) and multimedia device. It should be appreciated that a device may also be a nearly exclusive uplink only device, of which an example is a camera or video camera loading images or video clips to a network. The device may be a machine-type communications (MTC) device, an Internet of things (IoT) type communication device. The device may be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones, or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors, and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave).

One of the concepts considered to be used in 5G networks is network slicing in which multiple independent and dedicated virtual sub-networks (network instances) may be created within the same infrastructure to run services that have different requirements on latency, reliability, throughput, and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets, and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes, or hosts. Application of cloud RAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or NodeB (gNB).

It should be appreciated that MEC can be applied in 4G networks as well. 5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

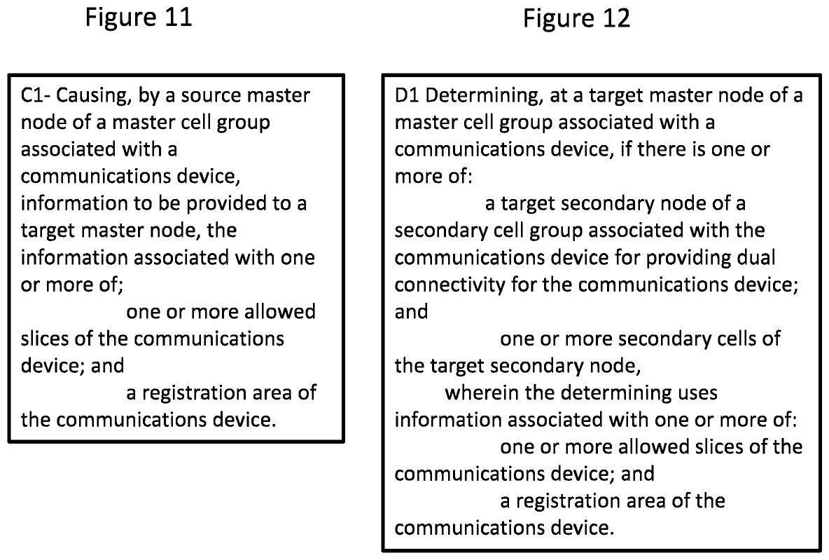

It is obvious for a person skilled in the art that the depicted system is only an example of a part of a radio access system and in practice, the system may comprise a plurality of (e/g)NodeBs, the device may have access to a plurality of radio cells and the system may comprise also other apparatuses, such as physical layer relay nodes or other network elements, etc. At least one of the (e/g)NodeBs or may be a Home (e/g)NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e/g)NodeBs of FIG. 11 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)gNodeBs), a home node B gateway, or HNB-GW (not shown in FIG. 1). A HNB Gateway (HNB-GW), which is typically installed within an operator's network may aggregate traffic from a large number of HNBs back to a core network.

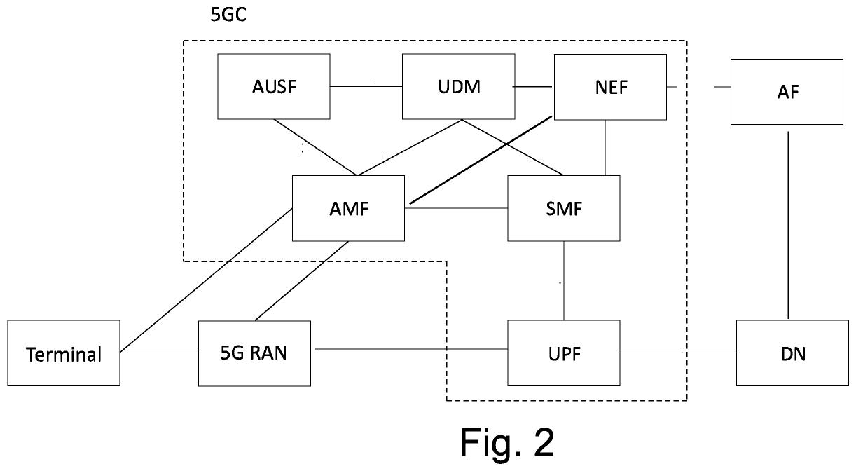

FIG. 2 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application functions (AF) and one or more data networks (DN).

The 5G-RAN may comprise one or more base stations. In 5G the base station may be referred to as a gNodeB (gNB). The RAN may comprise one or more gNodeB (gNB) (or base station) distributed unit functions connected to one or more gNodeB (gNB) (or base station) centralized unit functions.

The 5GC may comprise the following entities: one or more access management functions (AMF), one or more session management functions (SMF), an authentication server function (AUSF), a unified data management (UDM), one or more user plane functions (UPF), and/or a network exposure function (NEF).

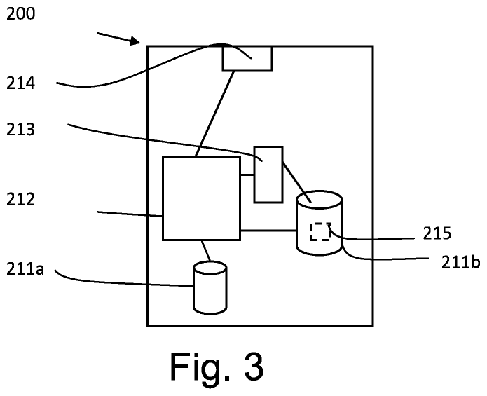

FIG. 3 illustrates an example of an apparatus 200. This apparatus may be provided for example in an AMF or a radio access node. The apparatus may comprise at least one memory. By way of example only the at least one memory may comprise random access memory (RAM) 211a and at least on read only memory (ROM) 211b. Apparatus used by other embodiments may comprise different memory.

The apparatus may comprise at least one processor 212, 213. In this example apparatus, two processors are shown.

The apparatus may comprise an input/output interface 214.

The at least one processor may be coupled to the at least one memory. The at least one processor may be configured to execute an appropriate software code 215. The software code 215 may for example allow the method of some embodiments to be performed.

The software code 215 may be stored in the at least one memory, for example ROM 211b.

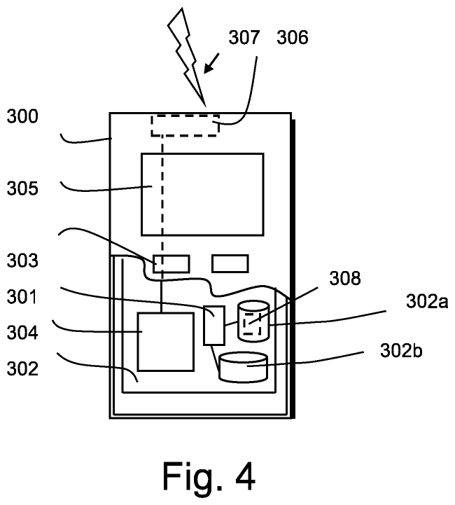

FIG. 4 illustrates an example of a device 300, such as the devices 100 and 102 illustrated in FIG. 1.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 311a and the ROM 311b. The at least one processor 301 may be configured to execute an appropriate software code 308. The software code 308 may for example allow to perform one or more of the present aspects. The software code 308 may be stored in the ROM 311b.

The processor, storage and other relevant control apparatus can be provided on an appropriate circuit board and/or in chipsets. This feature is denoted by reference 304.

The device may optionally have a user interface such as keypad 305, touch sensitive screen or pad, combinations thereof or the like.

Optionally one or more of a display, a speaker and a microphone may be provided depending on the type of the device.

In the following examples, the communications device is referred to as a UE. However, it should be appreciated that the communication device can any suitable communications device, some examples of which have already been mentioned.

Network slicing is provided in 5G. Network slicing supports different services using the same underlying mobile network infrastructure. One example of network slicing is described in 3GPP TS 38.300.

Network slices can differ in their service requirements. For example the service requirement may be an ultra-reliable low latency communication (URLLC) service requirement or an enhanced mobile broadband (eMBB) service requirement. Network slices can differ in the tenant that provides those services.

A network slice is uniquely identified via S-NSSAI (Single-Network Slice Selection Assistance Information). A UE may be simultaneously connected and served by a given maximum number of S-NSSAIs. In 3GPP TS 38.300, for example, the maximum is eight. For some embodiments, the maximum may be eight. Other embodiments may have a different maximum which may be more or less than eight.

Each cell may support tens or even hundreds of S-NSSAIs. For example, in 3GPP TS 38.300, a tracking area can have a support up to 1024 network slices. For some embodiments, the maximum number of supported slices may be 1024. Other embodiments may have a different maximum which may be more or less than 1024.

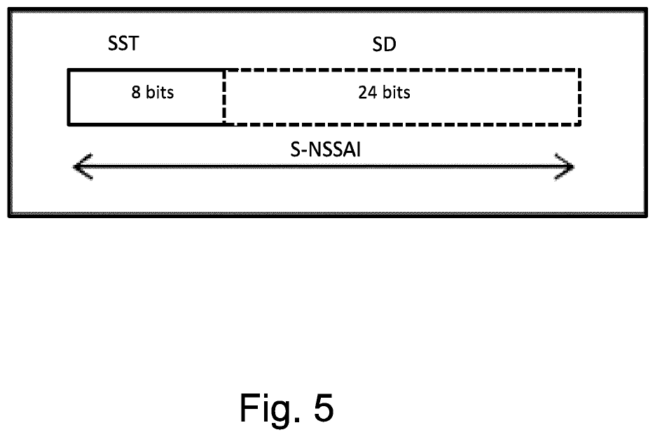

Reference is made to FIG. 5 which shows the format of a S-NSSAI. The S-NSSAI may comprise a slice service type (SST) and Slice Differentiator (SD) field. The total length of the S-NSSAI may be 32 bits with 8 bits for the SST and 24 bits for the SD field. Alternatively the S-NSSAI may include only the SST field part. In this latter case the length of the length of S-NSSAI is 8 bits only. The total length of the field and/or the length of individual fields may be different in other embodiments.

The SST field may have standardized values. Values 0 to 127 belong to the standardized SST range. For instance, SST value of 1 may indicate that the slice is suitable for handling of 5G eMBB, 2 for handling of URLLC, etc.

The SST may also comprise non-standardized values SD may be operator-defined only.

The SST field may have standardized and non-standardized values. Values 0 to 127 belong to the standardized SST range. For instance, SST value of 1 may indicate that the slice is suitable for handling of 5G eMBB, 2 for handling of URLLC, etc. SD is operator-defined only.

Registration area (RA) is a list consisting of tracking area (TA)s which is configured to the UE by the network. RA has been used to track a UE for paging purposes. In other terms, RA may comprise a list of TAs. If a UE leaves the RA, the UE would let the network know through a NAS (non-access stratum) registration request such that the correct RA can be configured to the UE.

In 5G, RA also has the role to maintain allowed slices (alternatively referred to as allowed NSSAI) of the UE. The allowed NSSAI is configured to the UE by the network. Reference in this document to an allowed S-NSSAI can refer to an S-NSSAI included in the allowed NSSAI. A UE NAS request can request access to a S-NSSAI. The network can decide to add that S-NSSAI to the UE's list or not.

The list of allowed slices or allowed NSSAI represents a list of slices which have been requested by the UE and allowed. This list of allowed slices includes one or more active slices (that is slices which are being used) and one or more inactive slices. An inactive slice is one which has been requested but not in use. An inactive slice may be one for which a PDU (packet data unit) session is set up and currently inactive or a slice for which a PDU session is likely to be set up. The inactive slice may be considered to a be a slice which is likely to be used but which is not yet used. The list of allowed slices may comprise a list of slices which are identified by a respective S-NSSAI. The allowed list may be referred to as allowed NSSAI in some standards provided by 3GPP.

It has been proposed to have homogenous slice support in a TA (tracking area). This means that the same slices are to be supported throughout a TA.

Dual connectivity (DC) may be supported. 5G supports (MR)-DC (multi-radio dual connectivity) where the UE can be served by a master cell group (MCG) and a secondary cell group (SCG) that are controlled by a master node (MN) and a secondary node (SN), respectively. The MCG consists of a primary cell (PCell) and one or more secondary cells (SCells) whereas the SCG consists of a primary secondary cell (PSCell) and one or more SCells.

Different forms of (MR)-DC may be supported in a 5G system. Some examples are given below:
E-UTRA-NR (evolved universal mobile telecommunications system (UMTS) terrestrial radio access new radio) dual connectivity (EN-DC) in which a UE is connected to one eNB that acts as MN and one EN-gNB that acts as SN.
NG-RAN (next generation radio access network) E-UTRA-NR dual connectivity (NGEN-DC), in which a UE is connected to one NG-eNB that acts as a MN and one gNB that acts as a SN.
NR-E-UTRA dual connectivity (NE-DC), in which a UE is connected to one gNB that acts as a MN and one NG-eNB that acts as a SN.
NR-NR dual connectivity (NR-DC), in which a UE is connected to one gNB that acts as a MN and another gNB that acts as a SN.

MN handover during DC operation is now described with reference to FIG. 5. This shows an inter-MN handover procedure with a same/different SN. FIG. 5 shows a message signalling flow of Inter-MN handover during DC operation which is set out in the 3GPP specification TS 37.340.

As referenced 1, the source MN sends a handover request to the target MN.

As referenced 2, the target MN sends an SN addition request to the target SN.

As referenced 3, the target SN sends an SN addition request acknowledgement to the target MN.

As referenced 4, the target MN sends a handover request acknowledgement to the source MN.

As referenced 5a, the source MN sends a SN release request to the source SN.

As referenced 5b, the source SN sends a SN release request acknowledgement to the source MN.

As referenced 5c, the source MN sends a Xn-U address indication to the source SN.

As referenced 6, the source MN sends a RRC (radio resource configuration) connection reconfiguration message to the UE.

As referenced 7, a random access procedure is performed between the UE and the target MN.

As referenced 8, the UE sends a RRC connection reconfiguration complete message to the target MN.

As referenced 9, a random access procedure is performed between the UE and the target SN.

As referenced 10, the target MN sends a SN reconfiguration complete message to the target SN.

As referenced 11a, the source SN sends a secondary RAT data usage report to the source MN.

As referenced 11b, the source MN sends the secondary RAT data usage report to the AMF.

As referenced 12a, the source SN sends a SN status transfer to the source MN.

As referenced 12b, the source MN sends the SN status transfer to the target MN.

As referenced 12c, the target MN sends the SN status transfer to the target SN.

As referenced 13, the UPF forwards data to the source MN and the source MN forwards data to the target MN.

As referenced 14, the target MN sends a path switch request to the AMF.

As referenced 15, the AMF and UPF perform bearer modification.

As referenced 16a, the UPF send a new path message (MN terminated bearer) to the target MN.

As referenced 16b, the UPF send a new path message (MN terminated bearer) to the target SN.

As referenced 17, the AMF send a path switch request acknowledgement to the target MN.

As referenced 18, the target MN sends a UE context release to the source MN.

As referenced 19, the source MN sends a UE context release to the source SN.

Some issues with the above current flow have been identified by the inventors.

If it is assumed that dual connectivity can be used only towards SN cells which belong to the current RA of the UE, then the MN may not be aware of the UE's RA. The core network assistance information for RRC inactive IE (information element) containing the RA is not a mandatory IE, i.e. the IE may or may not be delivered to the MN. In addition, the IE is used for inactive mode optimization, i.e. the IE is not used for SN selection. Even if it is assumed that the MN is aware of the RA, then some of the TAs of the SN may not belong to the RA of the UE and the SN might decide to add a cell (e.g. as referenced by 2/3 of FIG. 5) supporting a TA that is not included in the RA. Furthermore, it is unclear in an inter-MN handover scenario how the target MN stops the addition of a cell during DC operation that is disallowed by the above assumption. There may be a further issue in that the Xn handover request message does not include the registration area (RA) of the UE. Thus, the target MN will be unaware of the registration area (RA) of the UE. Another issue is that some DC operations cannot be initiated unless the UE's RA is updated by AMF. It is not clear how the AMF knows about this situation in order to trigger an RA update.

In case the above assumption, that is dual connectivity can be used only towards SN cells which belong to the current RA of the UE is not valid, this also raises issues. In the case where SN has multiple candidate cells to pick up and each of the candidate cells supports a different set of network slices (e.g. one only supporting the slice of the offloaded traffic and the other one supporting additionally other slices of the allowed S-NSSAIs) then the SN may choose a candidate cell which is not optimized for future traffic offload by the MN.

Some embodiments may address or mitigate one or more of the above described issues.

Some embodiments may provide methods for correcting cell addition through the SN in DC operation.

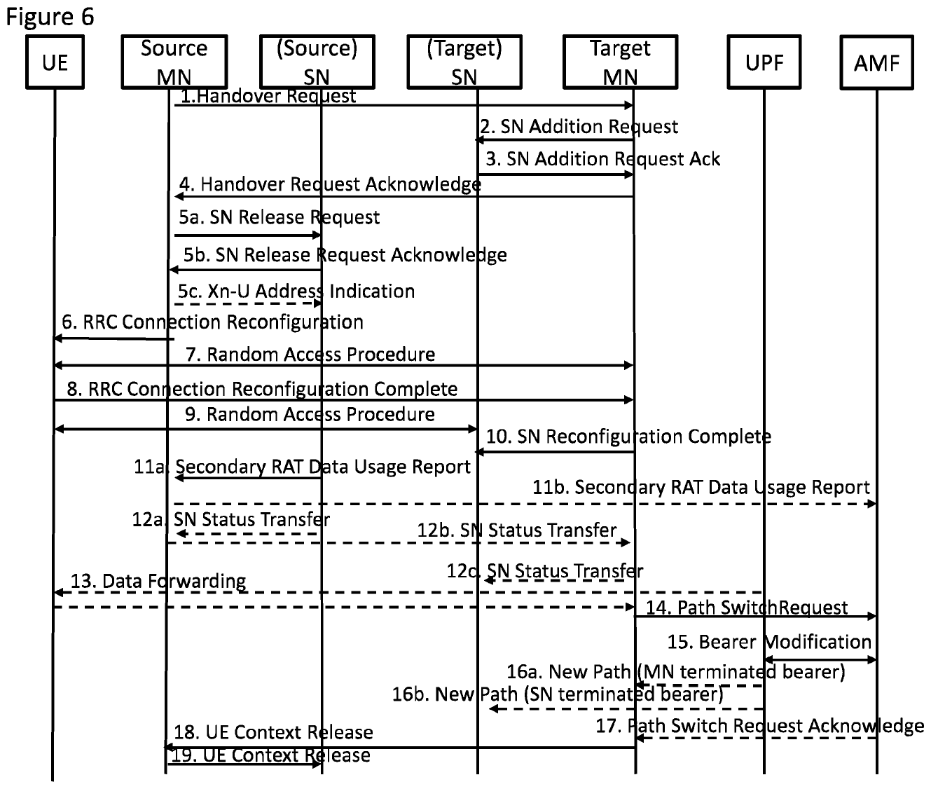

Reference is made to FIG. 6 which shows a first message flow of some embodiments. Various different embodiments will be described with reference to FIG. 6 as outlined below. It should be appreciated that these embodiments may be used on their own or combined with other of the embodiments.

As referenced 1, the source MN triggers an inter-MN handover. The source MN sends a handover request to the target MN.

As referenced 2, the target MN sends a SN addition request to the target SN.

As referenced 3, the target SN sends a SN addition request acknowledgement to the target MN.

As referenced 4, the target MN sends a handover request acknowledgement to the source MN.

As referenced 5, the source MN sends a RRC connection reconfiguration message to the UE.

As referenced 6, a connection is established between the UE and the target MN.

As referenced 7, the target MN sends a path switch request to the AMF.

As referenced 8, the AMF send a path switch request acknowledgement to the target MN.

As referenced 9, the target MN sends a UE context release to the source MN.

In first embodiments, the Registration Area (RA) of the UE and/or a list of allowed slices of the UE is delivered from one radio access network node to the other radio access network node. The RA and/or list of allowed slices itself may be delivered or in other embodiments, information about the RA and/or list of allowed slices may be delivered. The information about the RA and/or list of allowed slices allow the receiving radio access node to determine the RA and/or the list of allowed slices to be determined.

If both the RA and the list of allowed slices is delivered to the other radio access node, they may be provided together or separately.

In some embodiments, the RA and/or the list of allowed slices is available to the target MN during handover. In some embodiments the RA and/or the list of allowed slices is available to the target MS when it is setting up DC with a target SN.

The RA and/or the list of allowed slices may for example be provided to the target MN via a provided during an inter-MN handover. This may be by the source MN. The RA and/or the list of allowed slices may be provided in a handover request from a source node to the target node.

For example, the handover request may be an XnAP (Xn application protocol) handover request message. Xn is the interface between two NG-RAN nodes. It should be appreciated that in other standards, a different handover message or request may be provided In some embodiments, the RA and/or the list of allowed slices may be provided during an SN addition or modification process to a target SN. This may be by the target MN.

Where the message is provided during an SN addition or modification process, the message may be an XnAP SN-addition/modification request. It should be appreciated that in other standards, a different SN-addition/modification message or request may be provided For example, as part of the message flow referenced 1 of FIG. 5, the source MN sends an XnAP handover request along with the registration area (RA) and/or the list of allowed S-NSSAI of the UE.

The RA and/or S-NSSAI may be part of the handover request or may be provided together with the handover request.

For example, as part of the message flow referenced 2 of FIG. 5, the target MN sends SN-addition/modification request message to the target SN with the registration area and/or the list of allowed S-NSSAIs of the UE. The target SN can use the registration area or the list of allowed S-NSSAI of the UE to add relevant cells.

In the case of a conditional Inter-SN conditional primary secondary cell change, the target MN can build the list of candidate cells using the RA and the allowed S-NSSAI of the UE. A conditional Inter-SN conditional primary secondary cell change requires one or more conditions to be satisfied of the change to take place.

Delivering the RA of the UE to the target MN enables the target MN which wants to use the dual connectivity feature to select the SN with one or more TAs comprised in the RA of the UE and to send a list of candidate SN cells of that SN which belong to the RA of the UE. All candidate SN cells on the list may belong to the RA of the UE, or more particularly their TA belongs to the RA. Delivering the RA of the UE to the SN enables the SN to add the correct cell within a TA that is comprised in the RA of the UE.

The target secondary node may be selected based on one or more matches between the allowed NSSAI and a list of one or more slices supported by one or more secondary cells of one or more candidate target secondary nodes. Thus, in some embodiments, the allowed NSSAI is received by the target MN and used to in the matching.

Some embodiments, in addition to matching of the slices (active slices) associated with active PDU sessions, the matching also takes into account the inactive slices which are also in the allowed NSSAI. If there are for example two cells with equal matching for the active slices, in some embodiments, the cell which additionally supports inactive slices of the allowed NSSAI would be selected.

The matching may comprise maximizing the number of slices for which there is no ongoing associated PDU session and which are in common between the allowed NSSAI and the list of slices supported by one or more of the secondary cells.

The matching may comprise identifying a slice of the allowed NSSAI having the highest priority for which there is no ongoing associated PDU session and which is in common between the Allowed NSSAI and the list of slices supported by one or more of the secondary cells.

Alternatively or additionally, the allowed S-NSSAI(s) of the UE is delivered from one radio access network node to the other radio access network node. Delivering the allowed S-NSSAI(s) of the UE to the target MN allows the target MN to send a list of candidate SN cells which not only support the slices of the PDU (packet data unit) sessions it wants to offload but which also optimize the support of slices contained in the Allowed NSSAI.

Delivering the allowed S-NSSAI(s) of the UE to the SN allows the target SN to add the correct cell which only supports the slices which are requested to be offloaded but which also optimizes the support of slices contained in the Allowed NSSAI.

Thus, transmitting the RA and/or one or more allowed slices of the UE to the target MN and target SN may enable the selection of cell(s) for dual connectivity that belong to TA(s) that belong to the RA of the UE.

Although allowed slices are used herein as an example, it is noted that the information may additionally or alternatively comprise a list of configured slices. Thus, e.g. in addition to the allowed slice(s), configured slice(s) of the UE may also be considered for the dual connectivity. Configured slice defines a slice that UE subscription allows but it is not enabled currently. UE may enable said slice at a later time instance and thus said slice may become an allowed slice.

In second embodiments, the Registration Area (RA) of the UE is delivered from the core network to radio access network. This may be to be source MN or to the target MN. Any suitable message or messages may be used to provide the information to the source or target MN from the core network.

The message may be provided by the AMF or any other suitable mobility management network function. In a 5G system, the RA may be provided via a NGAP (next generation application protocol) initial context setup request and/or a NGAP handover request message. This enables the serving MN to become aware of the registration Area (RA) of a UE independently of the use of RRC inactive state for that UE.

Thus, for an NGAP handover, the RA may be included in the NGAP handover request message. To ensure that the target MN has the RA of the UE, the RA of the UE may be included in NGAP initial context setup request.

Thus, where there is an interface such as an Xn interface between the source MN and the target MN, the handover HO request can be transmitted directly between these nodes (as discussed in relation to the first embodiments). This may be referred to as an Xn HO.

Alternatively, the handover request can be sent from source MN to AMF and then from AMF to target MN (as discussed in relation to the second embodiments). This may be done where there is no interface between the source MN and the target MN. This may be referred to as an NG-based HO.

Aspects of the second embodiments may be used with aspects of the first embodiments.

In third embodiments, the TA of the SN added cell is added into a path switch request message. This may be a NGAP path switch message. This would allow the AMF to check that the new SN TA is well comprised in the RA. This may be used, for example, where dual connectivity can be used only towards SN cells which belong to the current RA of the UE. For example, as part of the message flow referenced 7 of FIG. 5, the MN sends a path switch request message including the TA of the added SN cell. This is to enable the AMF (or other mobility management function) to check that the RA comprises the TA added by the SN.

The third embodiments may be used with first and second embodiments.

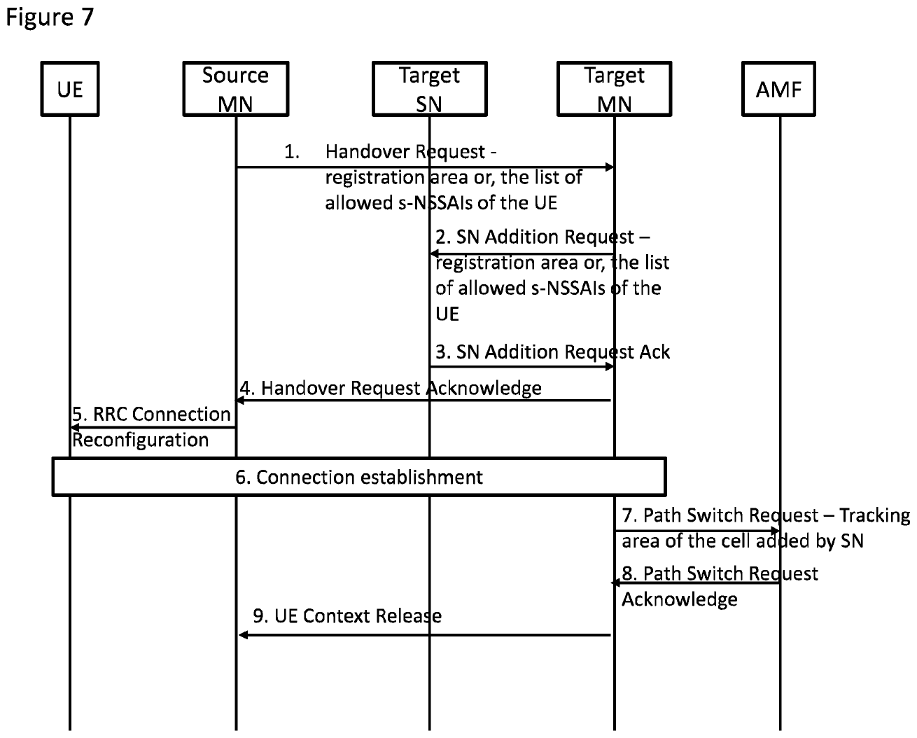

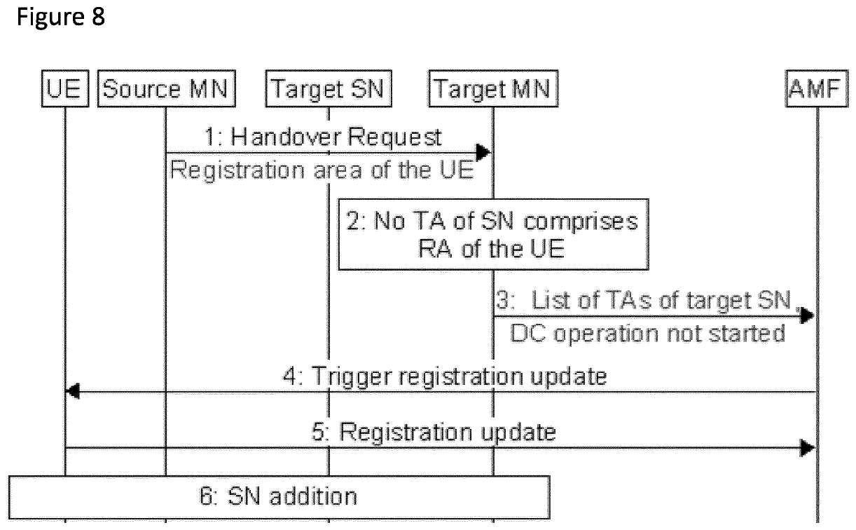

Fourth embodiments will now be described with reference to the message flow of FIG. 7. In this embodiment, the target MN signals a list of TAs of the candidate cells of the target SN to AMF (or other mobility management function) and indicates a DC operation could not be started. The AMF checks if any of the TAs of the candidate cells matches the allowed NSSAI of the UE. The AMF may decide to modify the current RA in order to enable the target MN to subsequently add an SN cell which is currently in a TA outside the RA.

As referenced 1, the source MN triggers an inter-MN handover. The source MN sends a handover request to the target MN. The target MN receives the RA of the UE. This may be as discussed previously.

As referenced 2, the target MN determines that it cannot add an SN as no SN comprises the RA of the UE.

As referenced 3, the target MN informs the AMF about the DC operation not being started and sends the list of TAs of the target SN to the AMF.

As referenced 4, the AMF triggers a registration update by adding one or more of the TAs of the target SN that supports the allowed NSSAI of the UE.

As referenced 5, the UE confirms to the AMF the registration update where the one or more TAs of the target SN are added.

As referenced 6, after this procedure, the target MN can initiate the DC operation and add the SN.

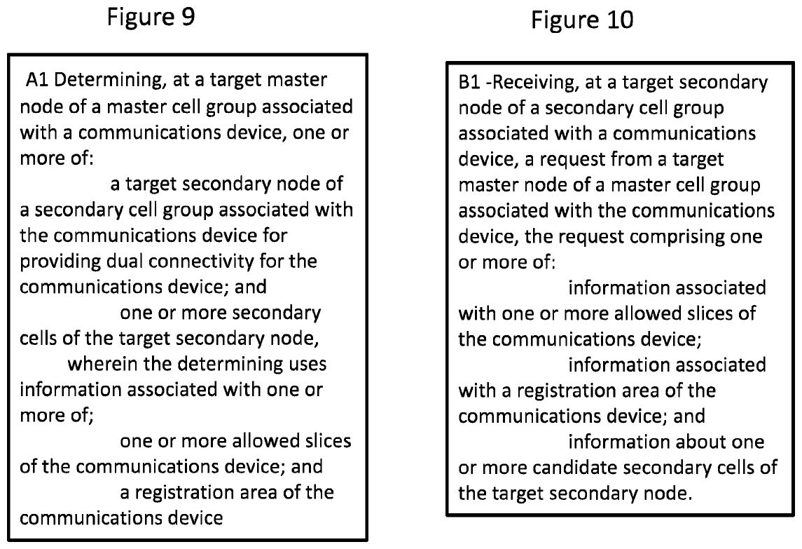

A method of some embodiments will now be described with reference to FIG. 9. The method may be performed by an apparatus. The apparatus may be provided in a RAN node or be an RAN node. The RAN node may be acting as a MN. The apparatus may be as shown for example in FIG. 2.

As referenced A1, the method comprises determining, at a target master node of a master cell group associated with a communications device, one or more of: a target secondary node of a secondary cell group associated with the communications device for providing dual connectivity for the communications device; and one or more secondary cells of the target secondary node. The determining may use information associated with one or more of, one or more allowed slices of the communications device; and a registration area of the communications device.

A method of some embodiments will now be described with reference to FIG. 10. The method may be performed by an apparatus. The apparatus may be provided in a RAN node or be an RAN node. The RAN node may be acting as a SN. The apparatus may be as shown for example in FIG. 2.

As referenced B1, the method comprises receiving, at a target secondary node of a secondary cell group associated with a communications device, a request from a target master node of a master cell group associated with the communications device, the request comprising one or more of: information associated with one or more allowed slices of the communications device; information associated with a registration area of the communications device; and information about one or more candidate secondary cells of the target secondary node.

A method of some embodiments will now be described with reference to FIG. 11. The method may be performed by an apparatus. The apparatus may be provided in a RAN node or be an RAN node. The RAN node may be acting as a MN. The apparatus may be as shown for example in FIG. 2.

As referenced Cl, the method comprises causing, by a source master node of a master cell group associated with a communications device, information to be provided to a target master node, the information associated with one or more of: one or more allowed slices of the communications device; and a registration area of the communications device.

A method of some embodiments will now be described with reference to FIG. 12. The method may be performed by an apparatus. The apparatus may be provided in a RAN node or be an RAN node. The RAN node may be acting as a MN. The RAN node may be a target MN. The apparatus may be as shown for example in FIG. 2.

As referenced D1, the method comprises determining, at a target master node of a master cell group associated with a communications device, if there is one or more of: a target secondary node of a secondary cell group associated with the communications device for providing dual connectivity for the communications device; and one or more secondary cells of the target secondary node.

The determining uses information associated with one or more of: one or more allowed slices of the communications device; and a registration area of the communications device.

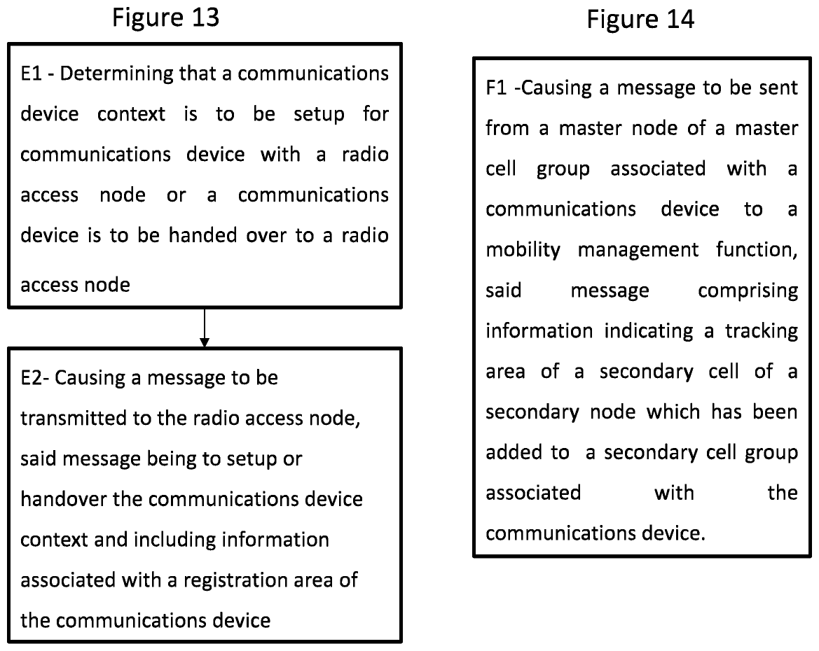

A method of some embodiments will now be described with reference to FIG. 13. The method may be performed by an apparatus. The apparatus may be provided in an AMF or other mobility management function or be an AMF or other mobility management function. The apparatus may be as shown for example in FIG. 2.

As referenced E1, the method comprises determining that a communications device context is to be setup for communications device with a radio access node or a communications device is to be handed over to a radio access node.

As referenced E2, the method comprises causing a message to be transmitted to the radio access node, said message being to setup or handover the communications device context and including information associated with a registration area of the communications device.

A method of some embodiments will now be described with reference to FIG. 14. The method may be performed by an apparatus. The apparatus may be provided in a RAN node or be an RAN node. The RAN node may be acting as a MN. The apparatus may be as shown for example in FIG. 2.

As referenced F1, the method comprises causing a message to be sent from a master node of a master cell group associated with a communications device to a mobility management function, the message comprising information indicating a tracking area of a secondary cell of a secondary node which has been added to a secondary cell group associated with the communications device.

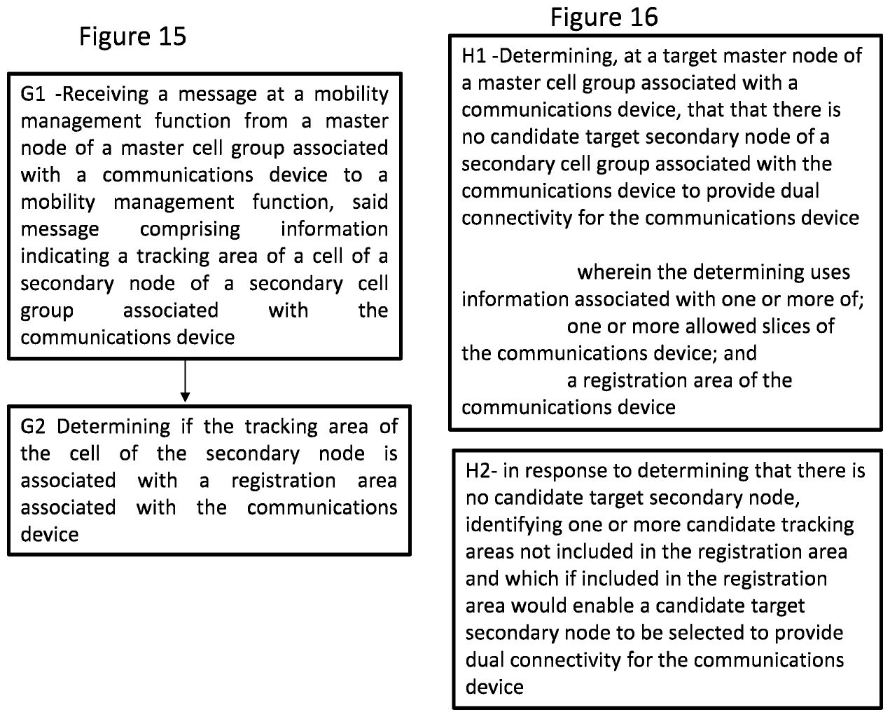

A method of some embodiments will now be described with reference to FIG. 15. The method may be performed by an apparatus. The apparatus may be provided in an AMF or other mobility management function or be an AMF or other mobility management function. The apparatus may be as shown for example in FIG. 2.

As referenced G1, the method comprises receiving a message at a mobility management function from a master node of a master cell group associated with a communications device to a mobility management function, the message comprising information indicating a tracking area of a cell of a secondary node of a secondary cell group associated with the communications device.

As referenced G2, the method comprises determining if the tracking area of the cell of the secondary node is associated with a registration area associated with the communications device.

A method of some embodiments will now be described with reference to FIG. 16. The method may be performed by an apparatus. The apparatus may be provided in a RAN node or be an RAN node. The RAN node may be acting as a MN. The apparatus may be as shown for example in FIG. 2.

As referenced H1, the method comprises determining, at a target master node of a master cell group associated with a communications device, that that there is no candidate target secondary node of a secondary cell group associated with the communications device to provide dual connectivity for the communications device. The determining uses information associated with one or more of: one or more allowed slices of the communications device; and a registration area of the communications device.

As referenced H2, the method comprises in response to determining that there is no candidate target secondary node, identifying one or more candidate tracking areas not included in the registration area and which if included in the registration area would enable a candidate target secondary node to be selected to provide dual connectivity for the communications device.

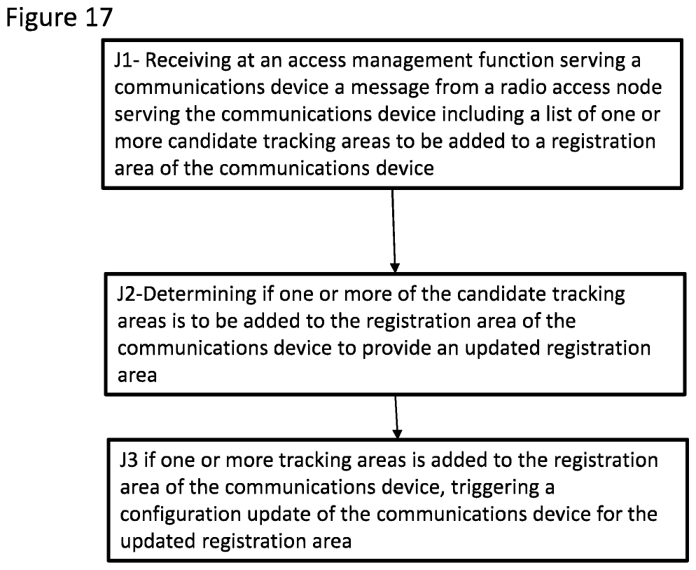

A method of some embodiments will now be described with reference to FIG. 17. The method may be performed by an apparatus. The apparatus may be provided in an AMF or other mobility management function or be an AMF or other mobility management function. The apparatus may be as shown for example in FIG. 2.

As referenced H1, the method comprises receiving at an access management function serving a communications device a message from a radio access node serving the communications device including a list of one or more candidate tracking areas to be added to a registration area of the communications device.

As referenced H2, the method comprises determining if one or more of the candidate tracking areas is to be added to the registration area of the communications device to provide an updated registration area.

As referenced H3, the method comprises if one or more tracking areas is added to the registration area of the communications device, triggering a configuration update of the communications device for the updated registration area.

### Examples

1. A method comprising:
   determining, at a target master node of a master cell group associated with a communications device, one or more of:
      a target secondary node of a secondary cell group associated with the communications device for providing dual connectivity for the communications device; and
      one or more secondary cells of the target secondary node,
   wherein the determining uses information associated with one or more of:
      one or more allowed and/or configured slices of the communications device; and
      a registration area of the communications device.
2. The method as in example 1, wherein the determining comprises determining the target secondary node from a plurality of candidate secondary nodes.
3. The method as in example 1 or 2, wherein the determining comprises determining the one or more secondary cells from a plurality of candidate secondary cells.
4. The method as in any preceding example 1 to 3, comprising receiving said information.
5. The method as in any preceding example 1 to 4, comprising receiving said information from a source master node.
6. The method of any preceding example 1 to 5, comprising receiving at the target master node a handover request for the target master node to be the master node of the master cell group associated with the communications device.
7. The method of example 6, comprising receiving the information in the handover request.
8. The method of any preceding example 1 to 7, wherein the information associated with the registration area comprises the registration area of the communications device.
9. The method of any preceding example 1 to 8, wherein the information associated with the one or more allowed and/or configured slices comprises a list of allowed slices and/or list of configured slices.
10. The method of example 9, wherein the list of allowed slices is provided by allowed network slice selection assistance information.
11. The method of any preceding example 1 to 10, comprising causing a request to be sent to the target secondary node.
12. The method of example 11, wherein the request to be sent to the target secondary node comprise a secondary node addition request.
13. The method of any of one of examples 11 or 12, wherein the request to be sent to the target secondary node comprises a secondary node modification request.
14. The method of any of examples 11 to 13, wherein the request to be sent to the target secondary node comprises information associated with one or more of:
   one or more allowed and/or configured slices of the communications device; and
   the registration area of the communications device
15. The method of example 14, wherein the information about the registration area in the request comprises the registration area.
16. The method of example 14 or 15, wherein the information about the one or more allowed slices in the request comprises allowed network slice selection assistance information.
17. The method of examples 11 to 16, wherein the request which is sent to the target secondary node comprises information about one or more candidate secondary node cells.
18. The method of example 17, wherein the one or more candidate secondary node cells belong to one or more tracking areas associated with the registration area of the communications device.
19. The method of any of examples 11 to 18, wherein the request which is sent to the target secondary node comprises information about one or more candidate secondary node cells supporting one or more slices of the one or more allowed and/or configured slices of the communications device.
20. The method of any preceding example 1 to 19, comprising determining the target secondary node based on a tracking area of the target secondary node being associated with the registration area.
21. The method of any preceding example 1 to 20, comprising determining the target secondary node based on one or more matches between one or more allowed and/or configured slices of the communications device and one or more slices supported by one or more secondary cells of one or more candidate target secondary nodes.
22. The method of example 11 or any example appended thereto, wherein the request to be sent to the target secondary node comprises one or more candidate secondary node cells based on one or more matches between one or more allowed slices of the communications device and one or more slices supported by the respective one or more candidate secondary cells of the target secondary node.
23. The method of example 21 or 22, wherein the one or more candidate target secondary nodes support one or more of the slices in an ongoing packet data unit session.
24. The method of any of examples 21 to 23, wherein the one or more matches are such as to maximize a number of slices for which there is no ongoing associated packet data unit session 25. The method of any of example 21 to 24, comprising identifying in the one or more matches of a slice of highest priority for which there is no ongoing associated packet data unit session.
26. The method of any preceding example 1 to 25, comprising causing a message to be sent from the target master node to a mobility management function, said message comprising information indicating a tracking area of a secondary cell of the target secondary node which has been added to the secondary cell group associated with the communications device.
27. A method comprising:
   determining, at a target master node of a master cell group associated with a communications device, if there is one or more of:
      a target secondary node of a secondary cell group associated with the communications device for providing dual connectivity for the communications device; and
      one or more secondary cells of the target secondary node,
   wherein the determining uses information associated with one or more of:
      one or more allowed and/or configured slices of the communications device; and
      a registration area of the communications device.
28. The method of example 27, wherein said determining determines there is no target secondary node which can be added to the secondary cell group and in response, the method comprises causing a message to be sent from the target master node to a mobility management function, said message comprising information that there is no secondary node which can be added to the secondary cell group.
29. The method of example 28, wherein the information in the message comprises information indicating that dual connectivity cannot be started for the communications device in dependence on the registration area of the communications device.
30. The method of example 27, 28 or 29, wherein the determining determines there is no target secondary node which can be added to the secondary cell group based on there being no target secondary nodes associated with the registration area of the communications device.
31. A method comprising:
   receiving, at a target secondary node of a secondary cell group associated with a communications device, a request from a target master node of a master cell group associated with the communications device, the request comprising one or more of:
      information associated with one or more allowed and/or configured slices of the communications device;
      information associated with a registration area of the communications device; and
      information about one or more candidate secondary cells of the target secondary node.
32. The method of example 31, comprising determining one or more target secondary node cells of the target secondary node based on a tracking area of the target secondary node which is associated with the registration area.
33. The method of example 31 or 32, comprising selecting one or more secondary node cells of the target secondary node based on a match between the information associated with one or more allowed and/or configured slices of the communications device and one or more slices supported by the respective secondary node cells.
34. The method of any of examples 31 to 33, wherein the information associated with the one or more allowed and/or configured slices comprises a list of allowed slices and/or a list of configured slices.
35. The method of example 34, wherein the list of allowed slices is provided by allowed network slice selection assistance information.
36. The method of any of examples 31 to 35, wherein the information associated with the registration area comprises the registration area of the communications device.
37. The method of any of examples 31 to 36, wherein the request comprises one of a secondary node addition request and a secondary node modification request.
38. A method comprising:
   causing, by a source master node of a master cell group associated with a communications device, information to be provided to a target master node, the information associated with one or more of:
      one or more allowed and/or configured slices of the communications device; and
      a registration area of the communications device.
39. The method of example 38, comprising receiving at the source master node information associated with the registration area of the communications device from an access management function.
40. The method of example 38 or 39, wherein the information is received by the source master node in an initial context setup message for the communications device.
41. The method of example 38 or 39, wherein the information is received by the source master node in a handover request message.
42. The method of any of examples 38 to 41, wherein the information is provided by the source master node to the target master node in a handover request for handing over from the source master node to the target master node.
43. The method of any of examples 38 to 42, wherein the information is used by the target master node when determining if there is one or more of: a target secondary node of a secondary cell group associated with the communications device for providing dual connectivity for the communications device; and one or more secondary cells of the target secondary node,
44. The method of any of examples 38 to 43, wherein the information associated with the registration area comprises the registration area of the communications device.
45. The method of any of examples 38 to 44, wherein the information associated with the one or more allowed and/or configured slices comprises a list of allowed slices and/or a list of configured slices.
46. The method of example 45, wherein the list of allowed slices is provided by allowed network slice selection assistance information.
47. A method comprising:
   determining that a communications device context is to be setup for communications device with a radio access node or a communications device is to be handed over to a radio access node; and
   causing a message to be transmitted to the radio access node, said message being to setup or handover the communications device context and including information associated with a registration area of the communications device.
48. The method of example 47, wherein the information associated with the registration area is the registration area of the communications device.
49. The method of any of examples 47 or 48, wherein the radio access node serves as master node of a master cell group associated with the communications device, in a dual connectivity relationship with the communications device.
50. The method of any one of examples 47 to 49, wherein the message comprises one or more of a one of an initial context setup message and an application protocol handover request message.
51. The method of any one of examples 47 to 50, wherein the message comprises one or more of a next generation application protocol initial context setup message and a next generation application protocol handover request message.
52. A method comprising:
   causing a message to be sent from a master node of a master cell group associated with a communications device to a mobility management function, said message comprising information indicating a tracking area of a secondary cell of a secondary node which has been added to a secondary cell group associated with the communications device.
53. A method comprising:
   receiving a message at a mobility management function from a master node of a master cell group associated with a communications device to a mobility management function, said message comprising information indicating a tracking area of a cell of a secondary node of a secondary cell group associated with the communications device; and
   determining if the tracking area of the cell of the secondary node is associated with a registration area associated with the communications device.
54. The method of example 53, comprising updating the registration area of the communications device based on the received information.
55. A method comprising:
   determining, at a target master node of a master cell group associated with a communications device, that that there is no candidate target secondary node of a secondary cell group associated with the communications device to provide dual connectivity for the communications device,
   wherein the determining uses information associated with one or more of:
      one or more allowed and/or configured slices of the communications device; and
      a registration area of the communications device; and
   in response to determining that there is no candidate target secondary node, identifying one or more candidate tracking areas not included in the registration area and which if included in the registration area would enable a candidate target secondary node to be selected to provide dual connectivity for the communications device.
56. The method of example 55, wherein the method comprises causing a message to be sent to a mobility management function including one or more of the identified candidate tracking areas.
57. The method of any of examples 55 and 56, wherein the information associated with the registration area comprises the registration area of the communications device.
58. The method of any of examples 55, 56 and 57, wherein the information associated with the one or more allowed and/or configured slices comprises a list of allowed slices and/or a list of configured slices.
59. The method of example 58, wherein the list of allowed slices is provided by allowed network slice selection assistance information.
60. The method of any of examples 55 to 59, comprising determining that there is no candidate target secondary node when there is no target secondary node associated with the registration area of the communications device.
61. The method of any of examples 1 to 60, wherein the information associated with a tracking area comprises a list of single-network slice selection assistance information supported by the tracking area.
62. A method comprising:
   receiving at an access management function serving a communications device a message from a radio access node serving the communications device including a list of one or more candidate tracking areas to be added to a registration area of the communications device:
   determining if one or more of the candidate tracking areas is to be added to the registration area of the communications device to provide an updated registration area; and
   if one or more tracking areas is added to the registration area of the communications device, triggering a configuration update of the communications device for the updated registration area.
63. The method of example 62, wherein the determining if one or more of the candidate tracking areas is to be added to the registration area of the communications device comprises determining, for each candidate tracking area, if a one or more slices associated with the communications device comprised in a list of slices for the candidate tracking area.
64. A computer program comprising computer executable code which when run on at least one processor causes the method of any one of the preceding examples 1 to 63 to be performed.
65. An apparatus comprising means for:
   determine, at a target master node of a master cell group associated with a communications device, one or more of:
      a target secondary node of a secondary cell group associated with the communications device for providing dual connectivity for the communications device; and
      one or more secondary cells of the target secondary node,
   wherein the determining uses information associated with one or more of,
      one or more allowed and/or configured slices of the communications device; and
      a registration area of the communications device.
66. An apparatus comprising:
   receiving, at a target secondary node of a secondary cell group associated with a communications device, a request from a target master node of a master cell group associated with the communications device, the request comprising one or more of:
      information associated with one or more allowed and/or configured slices of the communications device;
      information associated with a registration area of the communications device; and
      information about one or more candidate secondary cells of the target secondary node.
67. An apparatus comprising means configured to:
   cause, by a source master node of a master cell group associated with a communications device, information to be provided to a target master node, the information associated with one or more of,
      one or more allowed and/or configured slices of the communications device; and
      a registration area of the communications device.
68. The apparatus of example 67, wherein the information is provided by the source master node to the target master node in a handover request for handing over from the source master node to the target master node.
69. The apparatus of example 67 or 68, wherein the information is used by the target master node when determining if there one or more of: a target secondary node of a secondary cell group associated with the communications device for providing dual connectivity for the communications device; and one or more secondary cells of the target secondary node,
70. The apparatus of example 67, 68, or 69, wherein the information associated with the registration area comprises the registration area of the communications device.
71. The apparatus of example 67, 68, 69, or 70, wherein the information associated with the one or more allowed and/or configured slices comprises a list of allowed slices and/or a list of configured slices.
72. The apparatus of example 71, wherein the list of allowed slices is provided by allowed network slice selection assistance information.
73. An apparatus comprising means configured to:
   determine that a communications device context is to be setup for communications device with a radio access node or a communications device is to be handed over to a radio access node; and
   cause a message to be transmitted to the radio access node, said a message being to setup or handover the communications device context including information associated with a registration area of the communications device
74. The apparatus of example 73, wherein the information associated with the registration area is the registration area of the communications device.
75. The apparatus of example 73 or 74, wherein the radio access node serves as master node of a master cell group associated with the communications device, in a dual connectivity relationship with the communications device.
76. The apparatus of any one of examples 73 to 75, wherein the message comprises one or more of a one of an initial context setup message and an application protocol handover request message.
77. The apparatus of any one of examples 73 to 76, wherein the message comprises one or more of a next generation application protocol initial context setup message and a next generation application protocol handover request message.
78. An apparatus comprising means configured to:
   cause a message to be sent from a master node of a master cell group associated with a communications device to a mobility management function, said message comprising information indicating a tracking area of a secondary cell of a secondary node which has been added to a secondary cell group associated with the communications device.
79. An apparatus comprising means configured to:
   receive a message at a mobility management function from a master node of a master cell group associated with a communications device to a mobility management function, said message comprising information indicating a tracking area of a cell of a secondary node of a secondary cell group associated with the communications device; and
   determine if the tracking area of the cell of the secondary node is associated with a registration area associated with the communications device.
80. The apparatus of example 79, wherein the means is configured to update the registration area of the communications device based on the received information.
81. An apparatus comprising means configured to:
   determine, at a target master node of a master cell group associated with a communications device, that that there is no candidate target secondary node of a secondary cell group associated with the communications device to provide dual connectivity for the communications device
   wherein the determining uses information associated with one or more of,
      one or more allowed and/or configured slices of the communications device; and
      a registration area of the communications device; and
   in response to determining that there is no candidate target secondary node, identify one or more candidate tracking areas not included in the registration area and which if included in the registration area would enable a candidate target secondary node to be selected to provide dual connectivity for the communications device.
82. The apparatus of example 81, wherein the means is configured to cause a message to be sent to a mobility management function including one or more of the identified candidate tracking areas.
83. The apparatus of example 81 or 82, wherein the information associated with the registration area comprises the registration area of the communications device.
84. The apparatus of any of examples 81, 82 or 83, wherein the information associated with the one or more allowed and/or configured slices comprises a list of allowed slices and/or a list of configured slices.
85. The apparatus of example 84, wherein the list of allowed slices is provided by allowed network slice selection assistance information.
86. The apparatus of any of examples 81 to 85, wherein the means is configured to determine that there is no candidate target secondary node when there is no target secondary node associated with the registration area of the communications device.
87. The apparatus of any of examples 81 to 87, wherein the information associated with a tracking area comprises a list of single-network slice selection assistance information supported by the tracking area.
88. An apparatus comprising means configured to:
   receive at an access management function serving a communications device a message from a radio access node serving the communications device including a list of one or more candidate tracking areas to be added to a registration area of the communications device; and
   determine if one or more of the candidate tracking areas is to be added to the registration area of the communications device to provide an updated registration area; and
   if one or more tracking areas is added to the registration area of the communications device, trigger a configuration update of the communications device for the updated registration area.
89. The apparatus of example 88, wherein the means is configured to determining, for each candidate tracking area, if one or more slices associated with the communications device comprised in a list of slices for the candidate tracking area.
90. An apparatus comprising means configured to:
   determine, at a target master node of a master cell group associated with a communications device, if there is one or more of:
      a target secondary node of a secondary cell group associated with the communications device for providing dual connectivity for the communications device; and
      one or more secondary cells of the target secondary node,
   wherein the determining uses information associated with one or more of:
      one or more allowed and/or configured slices of the communications device; and
      a registration area of the communications device.
91. The apparatus of example 90, wherein means are configured, when said determining determines there is no target secondary node which can be added to the secondary cell group, to cause a message to be sent from the target master node to a mobility management function, said message comprising information that there is no secondary node which can be added to the secondary cell group.
92. The apparatus of example 91, wherein the information in the message comprises information indicating that dual connectivity cannot be started for the communications device in dependence on the registration area of the communications device.
93. The apparatus of any of examples 90 to 92, wherein means is configured to determine there is no target secondary node which can be added to the secondary cell group based on there being no target secondary nodes associated with the registration area of the communications device.

Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

Some embodiments may be implemented by circuitry. The term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions), and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, an integrated circuit or chiplet.

The embodiments of this disclosure may be implemented by computer software executable by a data processor, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks, and functions. The software may be stored on such physical media as memory chips, or memory blocks implemented within the processor, magnetic media such as hard disk or floppy disks, and optical media such as for example DVD and the data variants thereof, CD or any other suitable physical media. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory, and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples. Embodiments of the disclosure may be practiced in various components such as integrated circuit modules.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims.

However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising at least one processor and at least one memory including a computer program code, the at least one memory and computer program code configured to, with the at least one processor, cause the apparatus at least to:
determine, at a target master node of a master cell group associated with a communications device, one or more of:
a target secondary node of a secondary cell group associated with the communications device for providing dual connectivity for the communications device; and
one or more secondary cells of the target secondary node,
wherein the determining uses information associated with one or more of:
one or more allowed and/or configured slices of the communications device; and
a registration area of the communications device.

2. The apparatus as claimed in claim 1, wherein the apparatus is configured to determine the target secondary node from a plurality of candidate secondary nodes.

3. The apparatus as claimed in claim 1, wherein the apparatus is configured to determine the one or more secondary cells from a plurality of candidate secondary cells.

4. The apparatus as claimed in claim 1, wherein the apparatus is configured to receive said information.

5. The apparatus as claimed in claim 1, wherein the apparatus is configured to receive said information from a source master node.

6. The apparatus as claimed in claim 1, wherein the apparatus is configured to receive at the target master node a handover request for the target master node to be the master node of the master cell group associated with the communications device.

7. The apparatus of claim 6, wherein the apparatus is configured to receive the information in the handover request.

8. The apparatus as claimed in claim 1, wherein the information associated with the registration area comprises the registration area of the communications device.

9. The apparatus as claimed in claim 1, wherein the information associated with the one or more allowed and/or configured slices comprises a list of allowed slices and/or a list of configured slices.

10. The apparatus of claim 9, wherein the list of allowed slices is provided by allowed network slice selection assistance information.

11. The apparatus as claimed in claim 1, wherein the apparatus is configured to cause a request to be sent to the target secondary node.

12. The apparatus of claim 11, wherein the request to be sent to the target secondary node comprises a secondary node addition request.

13. The apparatus as claimed in claim 11, wherein the request to be sent to the target secondary node comprises a secondary node modification request.

14. The apparatus as claimed in claim 11, wherein the request to be sent to the target secondary node comprises information associated with one or more of:
one or more allowed and/or configured slices of the communications device; and
the registration area of the communications device

15. The apparatus of claim 14, wherein the information about the registration area in the request comprises the registration area.

16. The apparatus as claimed in claim 14, wherein the information about the one or more allowed slices in the request comprises allowed network slice selection assistance information

17. The apparatus as claimed in claim 11, wherein the request which is caused to be sent to the target secondary node comprises information about one or more candidate secondary node cells.

18. The apparatus as claimed in claim 17, wherein the one or more candidate secondary node cells belong to one or more tracking areas associated with the registration area of the communications device.

19-26. (canceled)

27. An apparatus comprising at least one processor and at least one memory including a computer program code, the at least one memory and computer program code configured to, with the at least one processor, cause the apparatus at least to:
receive, at a target secondary node of a secondary cell group associated with a communications device, a request from a target master node of a master cell group associated with the communications device, the request comprising one or more of:
information associated with one or more allowed and/or configured slices of the communications device;
information associated with a registration area of the communications device; and
information about one or more candidate secondary cells of the target secondary node;
wherein the apparatus is configured to select one or more secondary node cells of the target secondary node based on a match between the information associated with one or more allowed and/or configured slices of the communications device and one or more slices supported by the respective secondary node cells.

28-36. (canceled)

37. A method comprising:
determining, at a target master node of a master cell group associated with a communications device, one or more of:
a target secondary node of a secondary cell group associated with the communications device for providing dual connectivity for the communications device; and
one or more secondary cells of the target secondary node,
wherein the determining uses information associated with one or more of:
one or more allowed and/or configured slices of the communications device; and
a registration area of the communications device.

38-40. (canceled)
